(19) United States
(12) Patent Application Publication
(10) Pub. No.: US 2025/0077390 A1
(43) Pub. Date: Mar. 6, 2025

(54) BACKDOOR INSPECTION APPARATUS, METHOD, AND NON-TRANSITORY COMPUTER READABLE MEDIUM

(71) Applicant: NEC Corporation, Tokyo (JP)

(72) Inventors: Yusuke SHIMADA, Tokyo (JP); Shunichi KINOSHITA, Tokyo (JP); Daiki TANAKA, Tokyo (JP); Daichi ARAI, Tokyo (JP)

(73) Assignee: NEC Corporation, Tokyo (JP)

(21) Appl. No.: 18/795,468

(22) Filed: Aug. 6, 2024

(30) Foreign Application Priority Data
Aug. 28, 2023 (JP) 2023-137804

(51) Int. Cl. G06F 11/36

(52) U.S. Cl. CPC G06F 11/3636

(57) ABSTRACT

A backdoor inspection apparatus and the like with improved inspection accuracy of a backdoor trigger are provided. A backdoor inspection apparatus includes: an acquisition unit acquiring a program to be analyzed and starting point information of analysis; a data flow analysis unit analyzing a data flow included in the program, based on the acquired program to be analyzed and starting point information of analysis, and outputting data flow analysis information; and a conditional branch extraction unit extracting, as a candidate of a backdoor trigger, a conditional branch in which external input data are directly propagated, by using the data flow analysis information.

### INCORPORATION BY REFERENCE

This application is based upon and claims the benefit of priority from Japanese patent application No. 2023-137804, filed on Aug. 28, 2023, the disclosure of which is incorporated herein in its entirety by reference.

### TECHNICAL FIELD

The present disclosure relates to a backdoor inspection apparatus, a method, and a program.

### BACKGROUND ART

As one of measures against supply chain risk, importance of detecting an illegal function (backdoor) in a program is increasing. In order to inspect the illegal function (backdoor) installed in the program, high-cost analysis in reverse engineering by an expert is necessary.

Meanwhile, Japanese Unexamined Patent Application Publication No. 2009-098851 discloses an illegal code detection system that detects an illegal code during an evaluation test or the like when an application program or the like in an operating system is developed.

### SUMMARY

Incidentally, there is a technique of focusing on a conditional branch as a backdoor trigger, such as Stringer. However, inspection accuracy of the backdoor trigger is still insufficient because many conditional branches are used in a normal program.

The present disclosure has been made in order to solve such a problem, and an example object thereof is to provide a backdoor inspection apparatus, a method, a program, and the like that improve inspection accuracy of a backdoor trigger.

In a first example aspect of the present disclosure, a backdoor inspection apparatus includes: an acquisition unit configured to acquire a program to be analyzed and starting point information of analysis; a data flow analysis unit configured to analyze a data flow included in the program, based on the acquired program to be analyzed and starting point information of the analysis, and output data flow analysis information; and a conditional branch extraction unit configured to extract, as a candidate of a backdoor trigger, a conditional branch in which external input data are directly propagated, by using the data flow analysis information.

In a second example aspect of the present disclosure, a backdoor inspection method includes: acquiring a program to be analyzed and starting point information of analysis; analyzing a data flow included in the program, based on the acquired program to be analyzed and starting point information of the analysis, and outputting data flow analysis information; and extracting, as a candidate of a backdoor trigger, a conditional branch in which external input data are directly propagated, by using the data flow analysis information.

In a third example aspect of the present disclosure, a program causes a computer to execute: acquiring a program to be analyzed and starting point information of analysis; analyzing a data flow included in the program, based on the acquired program to be analyzed and starting point information of the analysis and outputting data flow analysis information; and extracting, as a candidate of a backdoor trigger, a conditional branch in which external input data are directly propagated, by using the data flow analysis information.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a diagram illustrating a configuration example of a backdoor inspection apparatus according to an example embodiment; FIG. 2 is a diagram for explaining an outline of a backdoor inspection method according to some example embodiments;

FIG. 3 is a diagram for explaining a specific example of a backdoor inspection method according to some example embodiments;

FIG. 4 is a diagram for explaining a backdoor inspection method according to some example embodiments;

FIG. 5 is a diagram for explaining a backdoor inspection method according to some other example embodiments;

FIG. 6 is a diagram for explaining a specific example of a data dependency relationship and a control dependency relationship according to some other example embodiments;

FIG. 7 is a diagram for explaining a specific configuration and advantageous effects of the backdoor inspection apparatus according to some example embodiments; and

FIG. 8 is a diagram illustrating an example of a hardware configuration of a backdoor inspection apparatus according to some example embodiments.

### EXAMPLE EMBODIMENT

Hereinafter, an example embodiment of the present invention will be described with reference to the drawings.

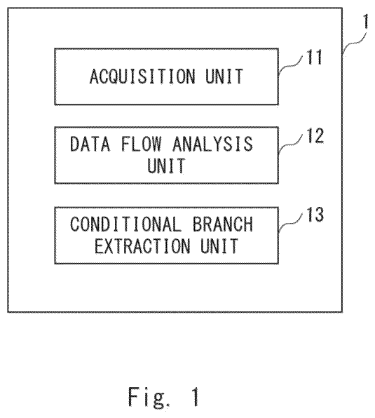

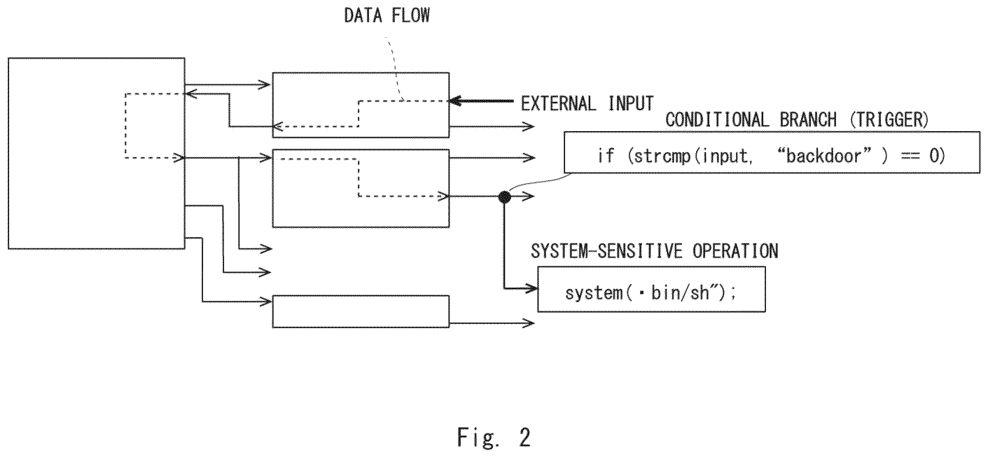

FIG. 1 is a diagram for explaining a configuration example of a backdoor inspection apparatus.

A backdoor inspection apparatus 1 receives a program to be analyzed and starting point information of an analysis, and inspects whether a backdoor is included in the program. The present disclosure focuses on a conditional branch, which can be a trigger for a backdoor in particular. The backdoor inspection apparatus 1 may be achieved by one or more computers including at least one memory for storing instructions and at least one processor for executing the instructions.

The backdoor inspection apparatus 1 includes an acquisition unit 11, a data flow analysis unit 12, and a conditional branch extraction unit 13. The acquisition unit 11 acquires a program to be analyzed and starting point information of an analysis. The program to be analyzed may include not only a source code but also a binary code. The analysis starting point may be an analysis initiation point, which is optionally set by an inspector. The acquired program to be analyzed can be stored in a storage unit of the backdoor inspection apparatus 1.

The data flow analysis unit 12 analyzes a data flow included in the program, based on the acquired program to be analyzed and starting point information of the analysis, and outputs data flow analysis information. The data flow analysis information includes a result of the data flow analysis. The data flow analysis refers to an analysis of how certain variable data are propagated in a program without changing its properties. More technically, the data flow analysis refers to analyzing whether there is a data dependency relationship between variables, and extracting data having a data dependency relationship. For example, it is possible to analyze how external input data are propagated in the program. The data flow analysis information may be displayed such that results of the data flow analysis can be recognized by an analyst (e.g., colored, enclosure lines, arrows, etc.) on the user interface.

The conditional branch extraction unit 13 extracts, as a candidate of a backdoor trigger, a conditional branch in which external input data are directly propagated, by using the analyzed data flow analysis information. The external input is data supplied from the outside of the program. The external input includes at least one of an input from an input device (e.g., a hardware keyboard, a software keyboard), an input via network communication, an input by file reading, an input by reading environment variables, and an input from other processes.

A conditional branch in which external input data are directly propagated is extracted from among a number of conditional branches. When the external input is, for example, a hidden password or a character string that can only be known by an attacker of the backdoor, a shell program of the backdoor may be started after the conditional branch outside the regular route. Therefore, the backdoor inspection can be performed with high accuracy by extracting a conditional branch in which external input data are directly propagated out of a large number of conditional branches in the program. However, a conditional branch in which the external input data are not directly propagated is not extracted, for example, because the conditional branch in which the external input is converted to a different property (for example, from a character string to a numerical value) and propagated is excluded from the candidate of the backdoor trigger.

One aspect of the present disclosure is a backdoor inspection method. Namely, the backdoor inspection method includes: acquiring a program to be analyzed and starting point information of an analysis; analyzing a data flow included in the program, based on the acquired program to be analyzed and the starting point information of the analysis, and extracting, as a candidate of a backdoor trigger, a conditional branch in which the external input data are directly propagated, by using the data flow analysis information.

One aspect of the present disclosure is a backdoor inspection program. Namely, the program causes a computer to execute: acquiring a program to be analyzed and starting point information of an analysis; analyzing a data flow included in the program, based on the acquired program to be analyzed and the starting point information of the analysis; and extracting, as a candidate of a backdoor trigger, a conditional branch in which external input data are directly propagated, by using the data flow analysis information.

FIG. 2 is a diagram for explaining an outline of a backdoor inspection method according to some example embodiments.

FIG. 2 illustrates a data flow of a certain program. Since many conditional branches are used in a normal program, it is not possible to enhance the accuracy of the backdoor inspection by simply focusing on the conditional branch as a backdoor trigger like Stringer of the existing technology. Note that, as used herein, a program may include not only a source code but also a binary code.

As a result of intensive studies, the inventors have found that, as illustrated in FIG. 2, a system-sensitive operation is executed from a conditional branch in which an external input is directly propagated. When a conditional branch meets certain requirements, processing transitions out of the regular route and a system-sensitive operation is performed. Certain requirements in this conditional branch are that sensitive operations (e.g., commands, file output, etc.) not to be originally executed are often executed, for example, when an external input, such as a password known only to an attacker, is input. For example, a hidden password from the outside may be input in the conditional branch, and the shell program may be started. The backdoor inspection system according to the present disclosure may include a backdoor inspection apparatus and an information processing device (including an input device) of an attacker connected to the backdoor inspection apparatus via a wired or wireless network.

In the present disclosure, by focusing on the conditional branch in which such external input is directly propagated, it is possible to detect not only a known backdoor but also an unknown backdoor. In addition, in the present disclosure, the backdoor included in the program can be inspected at low cost without requiring reverse engineering by an expert.

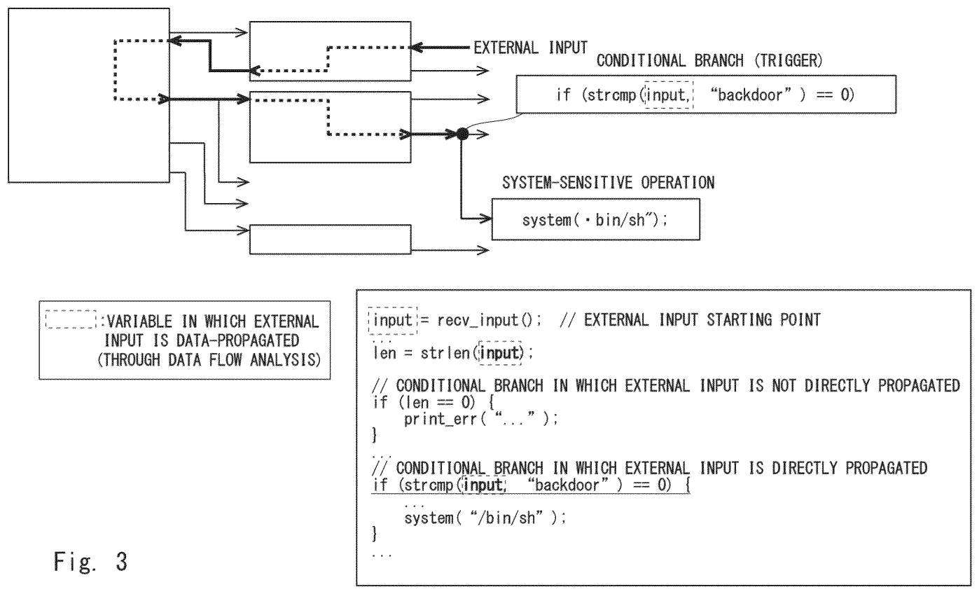

FIG. 3 is a diagram for explaining a relationship between a data flow and a program.

As illustrated in FIG. 3, variables constituting a conditional branch that is a backdoor trigger directly refer to the external input (or a propagation result thereof or a part of the input). Therefore, it is effective to utilize data flow analysis information from the external input in order to narrow down the candidates of the backdoor trigger from a number of conditional branches. By finding a variable (input in FIG. 3) in which external input data are propagated from the data flow analysis information indicating how the external input (input in FIG. 3) is propagated, it is possible to narrow down the candidates of the backdoor trigger from a number of conditional branches. The conditional branch branches the processing, based on the result of comparing values. Hereinafter, explanation will be given from the viewpoint of whether the external input data are directly propagated as a value to be compared in the conditional branch.

If an external input has its nature (e.g., number of characters from a character string) converted and data are propagated, such as len=strlen(input), this can be said to be a conditional branch in which the external input is not directly propagated.

On the other hand, if input is directly compared among conditional branches, such as if(input==“backdoor”)==0) (actually, as illustrated in FIG. 3, a strcmp function or the like is used), this can be said to be the conditional branch in which an external input is directly propagated. Namely, in the data flow analysis, the external input propagates at least a portion of the external input (e.g., all of the external input or some characters in front) without changing its nature, and the conditional branch being compared is extracted.

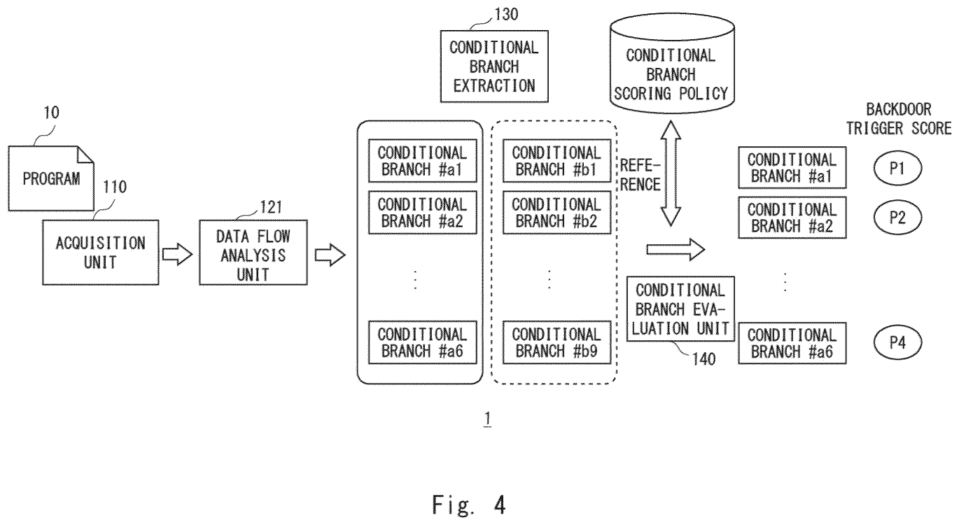

FIG. 4 is a diagram for explaining a backdoor inspection method according to some example embodiments.

A data flow analysis unit 121 performs data flow analysis for analyzing how data are propagated to the program acquired by an acquisition unit 110. As an analysis result, the data flow analysis unit 121 outputs the data flow analysis information to a conditional branch extraction unit 130.

The conditional branch extraction unit 130 extracts, from the data flow analysis information, a conditional branch (a group of conditional branches surrounded by a solid line in FIG. 4) in which an external input is directly propagated, as a candidate of a backdoor trigger. On the other hand, the conditional branch extraction unit 130 excludes a conditional branch (a group of conditional branches surrounded by a broken line in FIG. 4) in which the external input is not directly propagated.

Further, a conditional branch evaluation unit 140 may perform scoring according to characteristics of the conditional branch on some conditional branches in which the external input is directly propagated. Thus, by increasing the score of conditional branch such as character string comparison, it is possible to further enhance the accuracy of the backdoor inspection by prioritizing many conditional branches.

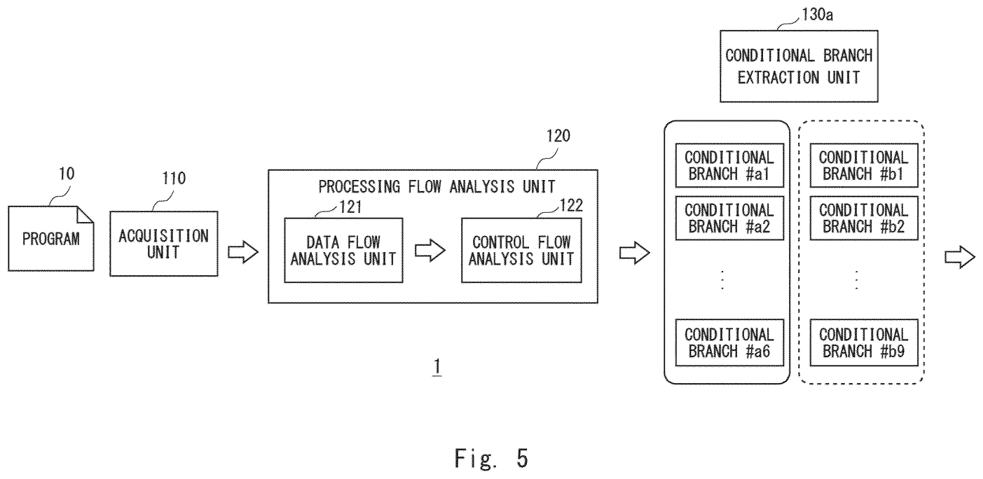

FIG. 5 explains a backdoor inspection method according to some other example embodiments.

In the present example embodiment, not only the data flow analysis but also the control flow analysis is performed on the program. Namely, a processing flow analysis unit 120 includes a data flow analysis unit 121 and a control flow analysis unit 122. The control flow analysis unit 122 performs a control flow analysis up to an end point of the analysis, based on the acquired program to be analyzed and the acquired starting point and end point of the analysis, and outputs control flow analysis information. The control flow analysis information includes a result of the control flow analysis. In addition, in the present example embodiment, the conditional branch to be extracted may be in an indirect data dependency relationship with an external input, in addition to the conditional branch having a direct data dependency relationship with an external input. Namely, a conditional branch extraction unit 130a also extracts a conditional branch having an indirect data dependency relationship with an external input, in addition to a conditional branch having a direct data dependency relation with an external input.

In order to acquire conditional branches such as those in indirect data dependency relationship with the external input, in addition to data flow analysis starting from the external input, analysis is performed on a control flow between the starting point and the end point of the analysis.

As described above, the data flow analysis refers to analysis of how a variable propagates in a program without changing its properties. More technically, the data flow analysis refers to analyzing whether there is a data dependency relationship between variables, and extracting data having a data dependency relationship. The data flow analysis information may be displayed such that the result of the data flow analysis can be recognized by an analyst (e.g., colored, enclosure lines, arrows, etc.) on the user interface. The data flow analysis information that has been output may be stored in a storage unit or the like of the backdoor inspection apparatus.

On the other hand, the control flow analysis refers to analyzing whether there is a control dependency relationship, i.e., whether the definition of the value of another variable is controlled according to the value or condition of a certain variable, which will be described in detail below. The control flow analysis information may be displayed such that a result of the control flow analysis can be recognized by an analyst (e.g., colored, enclosure lines, arrows, etc.) on the user interface. The control flow analysis information that has been output may be stored in, for example, a storage unit of the backdoor inspection apparatus.

Note that the end point information of the program to be analyzed may be added to the control flow analysis by an inspector. The end point information of the program may be stored in a database as inspection knowledge. The end point information may be selected from a list of functions that may, for example, be sensitive to the system (e.g., invoking a shell or writing important information to a file, etc.). The list of functions may be stored in a storage unit of the backdoor inspection apparatus.

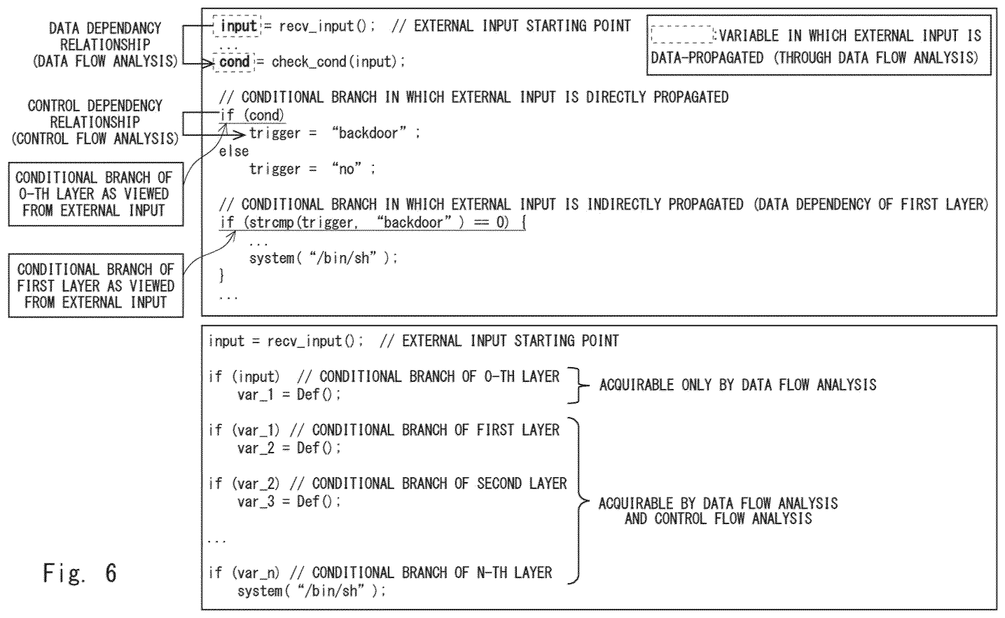

FIG. 6 is a diagram for explaining a specific example of a data dependency relationship and a control dependency relationship.

In FIG. 6, input=recv_input(); and cond=check_cond(input);, which are starting points of external inputs, are determined to have a data dependency relationship by data flow analysis.

Further, in FIG. 6, a variable of trigger contains a value of either “backdoor” or “no”, which is determined by the value of the variable called cond. Namely, the variable called cond controls the variable called trigger. Therefore, it can be said that the variable called cond and the variable called trigger have a control dependency relationship.

Next, it can be said that the conditional branch if (cond) is a conditional branch in which the external input is directly propagated because the variable called cond is directly indicated. In this specification, such a conditional branch is referred to as a conditional branch of the 0th layer when viewed from the external input.

The conditional branch if (strcmp(trigger, “backdoor”)==0) then contains the value of “backdoor” or “no” in the variable of trigger, which is determined by the value of the variable cond. Namely, the variable called cond controls the variable called trigger. The variable cond and the variable called trigger have a control dependency relationship. Therefore, in the present specification, the conditional branch if (strcmp(trigger, “backdoor”)==0) is said to be a conditional branch of the first layer when viewed from the external input. Such a conditional branch can be referred to herein as a conditional branch in which an external input is indirectly propagated.

As described above, in the present example embodiment, not only the conditional branch “if (cond)” but also the conditional branch “if (strcmp(trigger, “backdoor”)==0)” is an extraction target. An external input being indirectly propagated means that the external input input and the variable trigger have a relationship with a one-step control dependency in between. In the following description, the above-described relationship is defined as a data dependency of the first layer or a conditional branch of the first layer when viewed from an external input. Furthermore, in the lower diagram of FIG. 6, this relationship is extended to n layer (n is a positive integer) by combining data flow analysis and control flow analysis.

Further, according to the present example embodiment, by performing not only data flow analysis but also control flow analysis, it is possible to extract conditional branches that can affect subsequent instructions and operations.

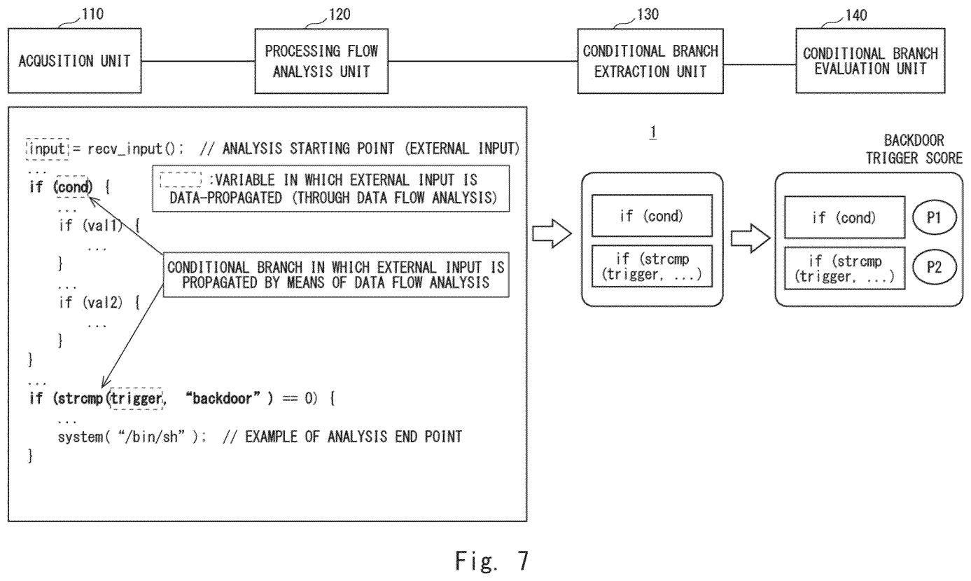

FIG. 7 is a diagram illustrating a specific configuration and advantageous effects of the backdoor inspection apparatus according to some example embodiments.

The acquisition unit 110 acquires a program to be analyzed, and a starting point and an end point of the analysis. The processing flow analysis unit 120 includes a data flow analysis unit 121 and a control flow analysis unit 122, and performs data flow analysis and control flow analysis between the starting point and the end point of the analysis. An external input, input=recv_input(); can be used as an example of the starting point of the analysis. As an example of the end point of the analysis, system (“/bin/sh”); may be used. The processing flow analysis unit 120 outputs processing flow analysis results including a data flow analysis result and a control flow analysis result.

The conditional branch extraction unit 130 receives the results of the processing flow analysis, and extracts a condition where the external input is directly propagated as a candidate of a backdoor trigger. Further, in some example embodiments, the conditional branch extraction unit 130 may receive the results of the processing flow analysis and extract a conditional branch in which an external input is directly or indirectly propagated.

The conditional branch evaluation unit 140 performs scoring on several extracted conditional branches according to a conditional branch scoring policy, and evaluates the backdoor trigger. The conditional branch scoring policy is predetermined by an analyst or the like, and may be stored in a storage unit of the backdoor inspection apparatus.

As described above, according to some example embodiments, it is possible to reduce the backdoor inspection cost by automatically extracting only a particularly suspicious conditional branch that can be a candidate of a backdoor trigger among the conditional branches included in the program.

The conditional branch evaluation unit 140 can score based on the number of layers viewed from the external input of the target conditional branch. For example, a condition of the 0th layer can be given a high score, and conditions of the first layer and subsequent layers can be given a low score. Alternatively, the larger the number of layers, the lower the score can be given.

In addition, from another viewpoint, a conditional branch may be evaluated and scored, and the sum of the scores may be used as a final evaluation. For example, a type of variables constituting the conditional branch and whether the comparison target is a specific character (or a character string) may be considered.

When scoring is performed based on the type of the variables constituting the conditional branch, for example, a high score can be given to a character string or a character string type. On the other hand, a low score can be given to a numerical type such as a file pointer or an integer type. For example, when an integer value is used as a backdoor trigger, even when a user other than an attacker provides the integer value at random, there is a risk that the user may activate the integer value as a backdoor trigger, and therefore, the attacker usually does not use the integer value as a backdoor trigger. In addition, among characters (or character strings), special characters (character strings for escape processing, null characters, and the like) may be excluded from the candidate of the backdoor trigger.

In some example embodiments, the conditional branch evaluation unit 140 scores the extracted conditional branch as to how likely the conditional branch is to be a backdoor trigger, depending on the layer of data dependency.

The conditional branch evaluation unit 140 increases the score of the backdoor trigger as the layer of the data dependency becomes shallower, or assigns a lower constant score to a conditional branch having a constant number of layers or more.

The conditional branch evaluation unit 140 scores the extracted conditional branch as to how likely the conditional branch is to be a backdoor trigger from a characteristic of type information of the variables constituting the conditional branch, based on the conditional branch scoring policy.

As described above, by using the conditional branch evaluation unit, it is possible to further improve the inspection accuracy of the backdoor trigger.

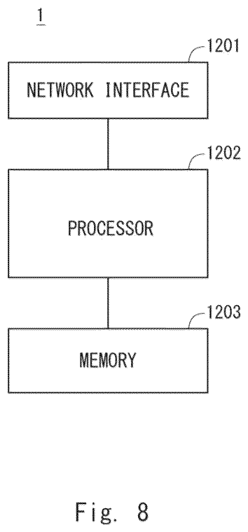

FIG. 8 is a block diagram illustrating a configuration example of the backdoor inspection apparatus 1. Referring to FIG. 8, the backdoor inspection apparatus 1 includes a network interface 1201, a processor 1202, and a memory 1203. The network interface 1201 is used for communicating with other network node apparatuses constituting a communication system. The network interface 1201 may be used for performing wireless communication. For example, the network interface 1201 may be used for performing wireless-LAN communication defined in IEEE802.11 series or mobile communication defined in 3GPP (registered trademark) (3rd Generation Partnership Project). Alternatively, the network interface 1201 may include a network interface card (NIC) compliant with IEEE 802.3 series, for example.

The processor 1202 reads and executes software (computer program) from the memory 1203 and thereby performs processing of the backdoor inspection apparatus 1 described by using the flowchart or the sequence in the above-described example embodiment. The processor 1202 may be, for example, a microprocessor, a Micro Processing Unit (MPU), a Central Processing Unit (CPU), or a Graphics Processing Unit (GPU). The processor 1202 may include a plurality of processors.

The memory 1203 is composed of a combination of a volatile memory and a non-volatile memory. The memory 1203 may include storage located remotely from the processor 1202. In this case, the processor 1202 may access the memory 1203 via an I/O interface, which is not illustrated.

In the example of FIG. 8, the memory 1203 is used for storing software modules. The processor 1202 reads and executes these software modules from the memory 1203, and thereby can perform the processing of the backdoor inspection apparatus 1 described in the above-described example embodiment.

As described with reference to FIG. 8, each of the processors of the backdoor inspection apparatus 1 executes one or a plurality of programs including instructions for causing a computer to perform the algorithm described with reference to the drawings. Note that the information processing device to be used by an attacker may be the same as the hardware configuration of FIG. 8.

In the examples described above, the program includes instructions (or software codes) that, when loaded into a computer, cause a computer to perform one or more of the functions described in the example embodiments. The program may be stored in a non-transitory computer-readable medium or a tangible storage medium. By way of example, and not limitation, the computer-readable medium or tangible storage medium includes random-access memory (RAM), read-only memory (ROM), flash memory, solid-state drive (SSD) or other memory techniques, CD-ROM, digital versatile disc (DVD), Blu-ray (registered trademark) disk or other optical disk storage, magnetic cassettes, magnetic tape, magnetic disk storage or other magnetic storage devices. The program may be transmitted on a transitory computer readable medium or a communication medium. By way of example, and not limitation, the transitory computer-readable medium or communication medium includes electrical, optical, acoustic, or other forms of propagated signals.

The present invention is not limited to the above-described example embodiments, and can be appropriately modified without departing from the spirit. The plurality of examples described above may be implemented in combination as appropriate.

Some or all of the above-described example embodiments may also be described as the following supplementary notes, but are not limited thereto.

### Supplementary Note 1

A backdoor inspection apparatus including:
an acquisition unit configured to acquire a program to be analyzed and starting point information of analysis;
a data flow analysis unit configured to analyze a data flow included in the program, based on the acquired program to be analyzed and starting point information of the analysis, and output data flow analysis information; and
a conditional branch extraction unit configured to extract, as a candidate of a backdoor trigger, a conditional branch in which external input data are directly propagated, by using the data flow analysis information.

### Supplementary Note 2

The backdoor inspection apparatus according to supplementary note 1, wherein the external input data are data supplied from an outside of a program, and includes at least one of an input from an input device, an input via a network communication, an input via a file reading, an input by reading an environment variable, and an input from another process.

### Supplementary Note 3

The backdoor inspection apparatus according to supplementary note 1 or 2, wherein a conditional branch in which the external input data are directly propagated includes a conditional branch in which the external input data are used as a comparison target without changing a property, and excludes a conditional branch in which the external input data change the property.

### Supplementary Note 4

The backdoor inspection apparatus according to any one of supplementary notes 1 to 3, wherein
the starting point information of the analysis is the external input data, and
the data flow analysis unit analyzes a data flow from the external input data to the program, based on the external input data being the acquired starting point information of the analysis.

### Supplementary Note 5

The backdoor inspection apparatus according to supplementary note 4, wherein
the acquisition unit further acquires end point information of analysis selected from a list of functions that can affect a system,
the backdoor inspection apparatus further includes a control flow analysis unit configured to analyze a control flow up to the end point of the analysis, based on the acquired program to be analyzed and the acquired starting point and end point of the analysis, and output control flow analysis information, and
the conditional branch extraction unit extracts, as a candidate of a backdoor trigger, a conditional branch in which the external input data are directly propagated, by using the data flow analysis information from the analyzed external input data and the control flow analysis information up to the end point of the analysis.

### Supplementary Note 6

The backdoor inspection apparatus according to supplementary note 5, wherein the conditional branch extraction unit uses the data flow analysis information and the control flow analysis information and thereby extracts, as candidates of backdoor triggers, conditional branches up to a n-th layer, in addition to the conditional branch of the 0-th layer as viewed from the external input data.

### Supplementary Note 7

The backdoor inspection apparatus according to any one of supplementary notes 1 to 6, further including a conditional branch evaluation unit configured to score the extracted conditional branch as to how likely the conditional branch is to be a backdoor trigger, depending on a layer of data dependency.

### Supplementary Note 8

The backdoor inspection apparatus according to supplementary note 7, wherein the conditional branch evaluation unit increases a score of a backdoor trigger as a layer of data dependency becomes shallower, or assigns a lower constant score to a conditional branch having a constant number of layers or more.

### Supplementary Note 9

The backdoor inspection apparatus according to any one of supplementary notes 1 to 8, further including a conditional branch evaluation unit configured to score the extracted conditional branch as to how likely the conditional branch is to be a backdoor trigger from a characteristic of type information of a variable constituting a conditional branch, based on a conditional branch scoring policy.

### Supplementary Note 10

A backdoor inspection method including:
acquiring a program to be analyzed and starting point information of analysis;
analyzing a data flow included in the program, based on the acquired program to be analyzed and starting point information of the analysis, and outputting data flow analysis information; and
extracting, as a candidate of a backdoor trigger, a conditional branch in which external input data are directly propagated, by using the data flow analysis information.

### Supplementary Note 11

A program causing a computer to execute:
acquiring a program to be analyzed and starting point information of analysis;
analyzing a data flow included in the program, based on the acquired program to be analyzed and starting point information of the analysis, and outputting data flow analysis information; and
extracting, as a candidate of a backdoor trigger, a conditional branch in which external input data are directly propagated, by using the data flow analysis information.

An example advantage according to the present disclosure is to provide a backdoor inspection apparatus and the like in which inspection accuracy of a backdoor trigger is improved.

What is claimed is:

1. A backdoor inspection apparatus comprising
at least one memory storing instructions, and
at least one processor configured to execute the instructions to:
acquire a program to be analyzed and starting point information of analysis;
analyze a data flow included in the program, based on the acquired program to be analyzed and starting point information of the analysis, and output data flow analysis information; and
extract, as a candidate for a backdoor trigger, a conditional branch in which external input data are directly propagated, by using the data flow analysis information.

2. The backdoor inspection apparatus according to claim 1, wherein the external input data are data supplied from an outside of a program, and includes at least one of an input from an input device, an input via network communication, an input by file reading, an input by reading an environment variable, and an input from another process.

3. The backdoor inspection apparatus according to claim 1, wherein a conditional branch in which the external input data are directly propagated includes a conditional branch in which the external input data are used as a comparison target without changing a property, and excludes a conditional branch in which the external input data change the property.

4. The backdoor inspection apparatus according to claim 1, wherein the starting point information of the analysis is the external input data, and the at least one processor is configured to execute the instructions to analyze a data flow from the external input data to the program, based on the external input data being the acquired starting point information of the analysis.

5. The backdoor inspection apparatus according to claim 4, wherein
the at least one processor is configured to execute the instructions to:
further acquire end point information of analysis that is selected from a list of functions which can affect a system;
analyze a control flow up to the end point of the analysis, based on the acquired program to be analyzed and the acquired starting point and end point of the analysis, and output control flow analysis information; and
extract, as a candidate of a backdoor trigger, a conditional branch in which the external input data are directly propagated, by using the data flow analysis information from the analyzed external input data and the control flow analysis information up to the end point of the analysis.

6. The backdoor inspection apparatus according to claim 5, wherein the at least one processor is configured to execute the instructions to use the data flow analysis information and the control flow analysis information, and thereby extract, as candidates of backdoor triggers, conditional branches up to a n-th layer, in addition to a conditional branch of a 0th layer as viewed from the external input data.

7. The backdoor inspection apparatus according to claim 1, wherein the at least one processor is configured to execute the instructions to score the extracted conditional branch as to how likely the conditional branch is to be a backdoor trigger, depending on a layer of data dependency.

8. The backdoor inspection apparatus according to claim 7, wherein the at least one processor is configured to execute the instructions to increase a score of a backdoor trigger as a layer of data dependency becomes shallower, or assign a lower constant score to a conditional branch having a constant number of layers or more.

9. The backdoor inspection apparatus according to claim 1, wherein the at least one processor is configured to execute the instructions to score the extracted conditional branch as to how likely the conditional branch is to be a backdoor trigger from a characteristic of type information of a variable constituting the conditional branch, based on a conditional branch scoring policy.

10. A backdoor inspection method comprising:
acquiring a program to be analyzed and starting point information of analysis;
analyzing a data flow included in the program, based on the acquired program to be analyzed and starting point information of the analysis, and outputting data flow analysis information; and
extracting, as a candidate of a backdoor trigger, a conditional branch in which external input data are directly propagated, by using the data flow analysis information.

11. A non-transitory computer readable medium storing a program causing a computer to execute: acquiring a program to be analyzed and starting point information of analysis;
analyzing a data flow included in the program, based on the acquired program to be analyzed and starting point information of the analysis, and outputting data flow analysis information; and
extracting, as a candidate of a backdoor trigger, a conditional branch in which external input data are directly propagated, by using the data flow analysis information.
